(19) United States
(12) Patent Application Publication
(10) Pub. No.: US 2006/0123194 A1
(43) Pub. Date: Jun. 8, 2006

(54) Variable effective depth write buffer and methods thereof

(76) Inventors: Claudio Alex Cukierkopf, Ranana (IL); Avi Davis, Hod HaSharon (IL); Roy Glasner, Ramat Gan (IL)

Correspondence Address: PEARL COHEN ZEDEK, LLP, 1500 BROADWAY 12TH FLOOR, NEW YORK, NY, 10036, US

(21) Appl. No.: 11/001,002

(22) Filed: Dec. 2, 2004

(51) Int. Cl. G06F 12/00

(52) U.S. Cl. 711/118; 711/138

(57) ABSTRACT

Data chunks are propagated through a write buffer from an input storage element to an output storage element by bypassing one or more intermediate storage elements of the write buffer.

### BACKGROUND OF THE INVENTION

The execution of machine language instructions by a processor may involve storing data chunks in a destination device, such as a system memory or a cache memory. For reasons such as prioritization of accesses to the destination device, or for any other reason, the destination device may not be accessible for storing the data chunks at the same time the data chunks are available to be stored.

In order to bridge the time gap between the availability of the data chunks and the accessibility of the destination device, or for any other reason, an intermediate buffer (“write buffer”) may be used in the processor to temporarily store the data chunks until they can be stored in the destination device.

Such a write buffer may be implemented, for example, as a pointer-based first-in-first-out (FIFO) memory. The pointer-based FIFO may include, for example, a random access memory, and a control unit may select any entry in the random access memory to store a data chunk received through an input port of the FIFO. In addition, the control unit may control an output multiplexing unit of the FIFO to retrieve the data chunks from the random access memory in the same order the data chunks were received through the input port, and may control outputting the data chunks through an output port. A specific data chunk is written to and read from only one location in the random access memory. The read and write pointers of the FIFO change from one data chunk to another.

In another example, a write buffer may be implemented as a shift-based FIFO memory. The shift-based FIFO may have an input storage element, an output storage element and intermediate storage elements. A data chunk received through an input port of the write buffer may be initially stored in the input storage element, and may propagate through all the intermediate storage elements, one at a time, according to the availability of empty storage elements and accessibility of the destination device, until it is stored in the output storage element. The destination device may receive the data chunk from the output storage element of the write buffer.

A write buffer implemented using a pointer-based FIFO may have dynamic power consumption that is lower than the dynamic power consumption of a write buffer implemented using a shift-based FIFO. One possible reason for the difference in dynamic power consumption may be that a data chunk that is written to one entry of the pointer-based FIFO is outputted from the same entry, while a data chunk is propagated through several storage element of the shift-based FIFO before being outputted.

On the other hand, a write buffer implemented using a pointer-based FIFO may require more silicon area than a write buffer implemented using a shift-based FIFO, and may have higher combinatorial propagation delays that may impair the frequency performance of the pointer-based FIFO write buffer. One possible reason for the larger silicon area and the lower frequency performance may be the output multiplexing unit of the pointer-based FIFO.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a block diagram of an exemplary device including a processor coupled to a data memory and to a program memory;

FIG. 2 is a block diagram of an exemplary write buffer, according to some embodiments of the invention; and

FIG. 3 is a block diagram of another exemplary write buffer, according to an embodiment of the invention.

It will be appreciated that for simplicity and clarity of illustration, elements shown in the figures have not necessarily been drawn to scale. For example, the dimensions of some of the elements may be exaggerated relative to other elements for clarity

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

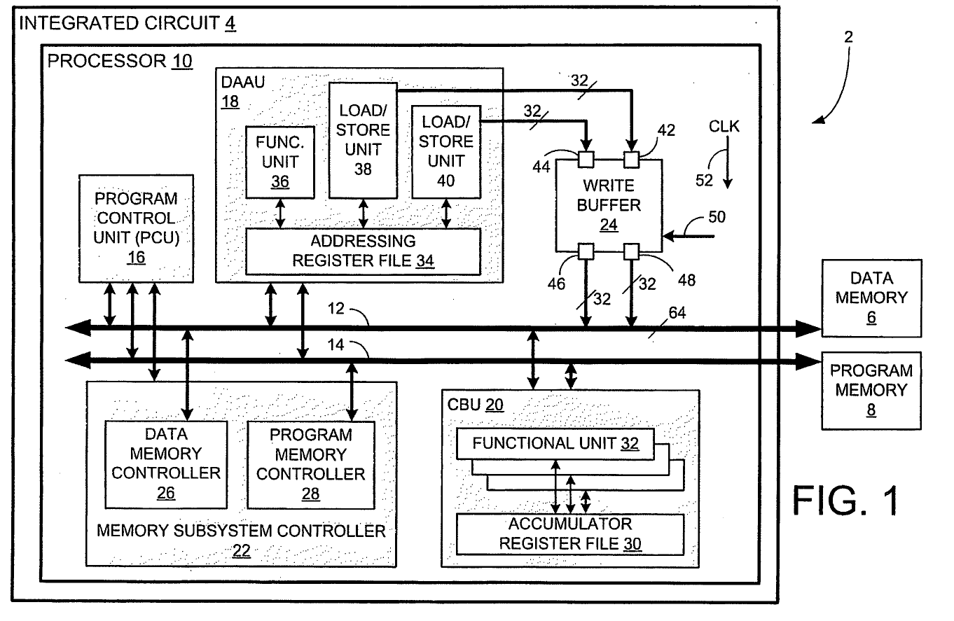

FIG. 1 is a block diagram of an exemplary apparatus 2 including an integrated circuit 4, a data memory 6 and a program memory 8. Integrated circuit 4 includes an exemplary processor 10 that may be, for example, a digital signal processor (DSP), and processor 10 is coupled to data memory 6 via a data memory bus 12 and to program memory 8 via a program memory bus 14. Data memory 6 and program memory 8 may be the same memory or alternatively, separate memories. An exemplary architecture for processor 10 will now be described, although other architectures are also possible. Processor 10 includes a program control unit (PCU) 16, a data address and arithmetic unit (DAAU) 18, a computation and bit-manipulation unit (CBU) 20, a memory subsystem controller 22 and a write buffer 24. Memory subsystem controller 22 includes a data memory controller 26 coupled to data memory bus 12 and a program memory controller 28 coupled to program memory bus 14. PCU 16 is to retrieve, decode and dispatch machine language instructions and is responsible for the correct program flow. CBU 20 includes an accumulator register file 30 and functional units 32, having any of the following functionalities or combinations thereof: multiply-accumulate (MAC), add/subtract, bit manipulation, arithmetic logic, and general operations. DAAU 18 includes an addressing register file 34, a functional unit 36 having arithmetic, logical and shift functionality, and load/store units (LSU) 38 and 40 capable of loading and storing data chunks from/to data memory 6.

Write buffer 24 may be able to receive from LSU 38 and 40, via input ports 42 and 44, respectively, data chunks to be stored in data memory 6, and to store the received data chunks internally. Write buffer 24 may be able to receive data chunks from elsewhere in processor 10 and to store the received data chunks internally. In some processors, the size of a data chunk may be variable, whereas in other processors, the size of a data chunk may be fixed. The size of a data chunk may be any number of bits; the following description is for a fixed size of 32 bits.

Output ports 46 and 48 of write buffer 24 may be coupled to, for example, data memory bus 12, and write buffer 24 may be able to output internally stored data chunks through output ports 46 and/or 48 to data memory bus 12, prior to these data chunks being stored in data memory 6.

32-bit address buses from LSU 38 to input port 42, from LSU 40 to input port 44, from output port 46 to data memory bus 12 and from output port 48 to data memory bus 12, as well as the 32-bit address portion of data memory bus 12 are not shown in FIG. 1.

Write buffer 24 may receive control signals 50 that may be generated by CBU 20 and/or DAAU 18 and/or PCU 16 and/or memory subsystem controller 22 and/or any other unit of processor 10. Control signals 50 may control reception of data chunks by write buffer 24 and may control outputting the data chunks by write buffer 24.

In addition, control signals 50 may control the number of cycles of a clock 52 that pass from reception of a particular data chunk by write buffer 24 and outputting the particular data chunk from write buffer 24. Clock 52 is not necessarily a regular clock with cycles of a fixed time period. Rather, clock 52 may be generated by any logic function and different cycles of clock 52 may have different time periods.

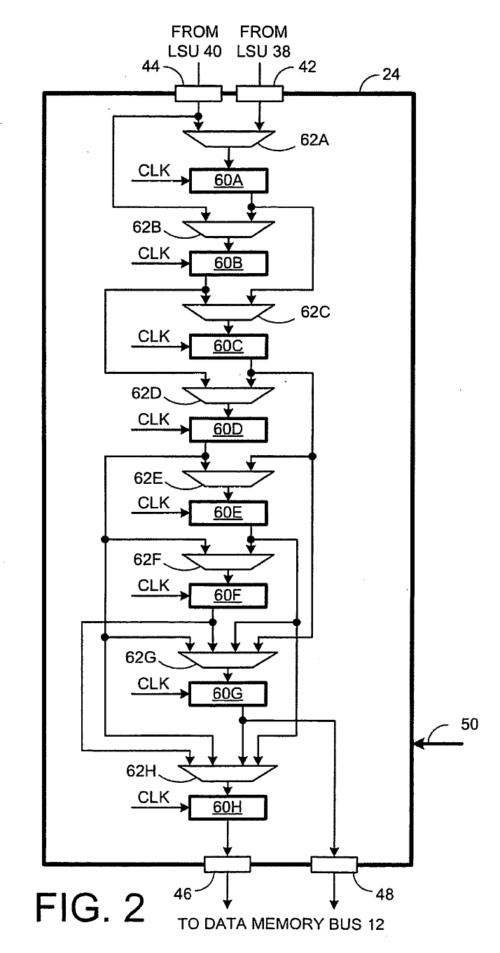

FIG. 2 is an exemplary block diagram of write buffer 24, according to some embodiments of the invention. Write buffer 24 includes a plurality of storage elements 60 to store data chunks. A non-exhaustive list of examples for storage elements 60 includes registers, latches, and the like. Storage elements 60 are activated by clock 52 and optionally by control signals 50. In the example shown in FIG. 2, write buffer 24 includes eight storage elements 60A, 60B, 60C, 60D, 60E, 60F, 60G and 60H. Storage elements 60A and 60B are input storage elements, storage elements 60B, 60C, 60D, 60E, 60F and 60G are intermediate storage elements, and storage elements 60G and 60H are output storage elements. However, a write buffer according to embodiments of the invention may include any number of storage elements.

Write buffer 24 is a dual-input, dual-output write buffer. Write buffer 24 may include one or more routing blocks 62, controlled by control signals 50, to provide alternative propagation paths for data chunks from input ports 42 and 44 to output ports 46 and 48. In the example shown in FIG. 2, write buffer 24 includes eight intermediate routing blocks 62A, 62B, 62C, 62D, 62E, 62F, 62G and 62H. However, a write buffer according to embodiments of the invention may include any number of routing blocks. A multiplexer is an example of a routing block.

In write buffer 24, routing blocks 62A, 62B, 62C, 62D, 62E and 62F each have two data-chunk-sized inputs and one data-chunk-sized output. Routing blocks 62G and 62H each have four data-chunk-sized inputs and one data-chunk-sized output Control signals 50 couple one of the inputs of a routing block to the output of the routing block.

Routing block 62A couples input ports 42 and 44 to storage element 60A. Routing block 62B couples input port 44 and storage element 60A to storage element 60B.

Routing block 62C couples storage elements 60A and 60B to storage element 60C. Routing block 62D couples storage elements 60B and 60C to storage element 60D. Routing block 62E couples storage elements 60C and 60D to storage element 60E. Routing block 62F couples storage elements 60D and 60E to storage element 60F.

Routing block 62G couples storage elements 60C, 60D, 60E and 60F to storage element 60G. Routing block 62H couples storage elements 60D, 60E, 60F and 60G to storage element 60H. The output of storage element 60G is coupled to output port 48, and the output of storage element 60H is coupled to output port 46.

Lengths of alternative propagation paths are independently selectable for each data chunk received through input port 42 or 44. Different lengths of propagation paths result in a variable effective depth of the write buffer.

Many different propagation paths are possible in write buffer 24. Arbitrarily selected, some propagation paths are presented in TABLE 1 to demonstrate possible lengths of alternative propagation paths. Each row of TABLE 1 represents a propagation path. The length of a propagation path is recorded as the number of storage elements through which a data chunk is propagated, and the storage elements that form part of the propagation path are marked with “X”.

TABLE 1

| | Path | Input | S.E. | S.E. | S.E. | S.E. | S.E. | S.E. | S.E. | S.E. | Output |
|---|---|---|---|---|---|---|---|---|---|---|---|
| Path | Length | Port | 60A | 60B | 60C | 60D | 60E | 60F | 60G | 60H | Port |
| a | 8 | 42 | X | X | X | X | X | X | X | X | 46 |
| b | 7 | 42 | X | X | X | X | X | X | X | | 48 |
| c | 6 | 42 | X | X | X | X | | X | X | | 48 |
| d | 5 | 42 | X | X | X | X | | | X | | 48 |
| e | 4 | 42 | X | | X | | X | | X | | 48 |
| f | 8 | 44 | X | X | X | X | X | X | X | X | 46 |
| g | 7 | 44 | | X | X | X | X | X | X | X | 46 |
| h | 6 | 44 | | X | X | X | X | X | | X | 46 |
| i | 5 | 44 | | X | X | X | X | | | X | 46 |
| j | 4 | 44 | | X | | X | | X | | X | 46 |

It should be noted that one configuration of routing blocks 62 concurrently provides path “e” from input port 42 to output port 48 via storage elements 60A, 60C, 60E and 60G and path “j” from input port 44 to output port 46 via storage elements 60B, 60D, 60F and 60H. Path “e” and path “j” each delay the data chunks by at least 4 clock cycles. If a destination device is not accessible, the delay may be even longer. A different configuration of routing blocks provides path “a” from input port 42 to output port 46 via all the storage elements 60A-60H. Path “a” delays the data chunks by at least 8 clock cycles. If a destination device is not accessible, the delay may be even longer. Yet another configuration of routing blocks provides path “d” from input port 52 to output port 48 via storage elements 60A, 60B, 60C, 60D and 60G.

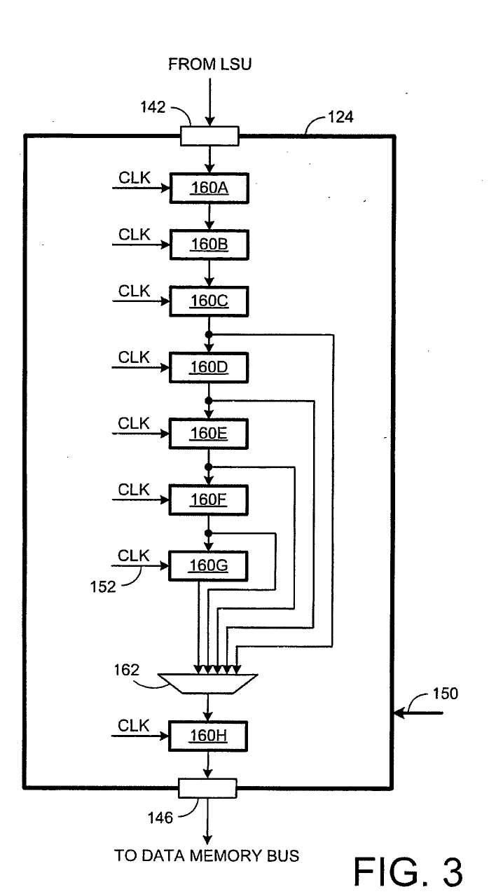

FIG. 3 is a block diagram of another exemplary write buffer 124, according to some embodiments of the invention. Write buffer 124 includes a plurality of storage elements 160 to store data chunks. A non-exhaustive list of examples for storage elements 160 includes registers, latches, and the like. Storage elements 160 are activated by a clock 152 and optionally by control signals 150. In the example shown in FIG. 3, exemplary write buffer 124 includes eight storage elements 160A, 160B, 160C, 160D, 160E, 160F, 160G and 160H. Storage element 160A is an input storage element, storage elements 160B-160G are intermediate storage elements and storage element 160H is an output storage element. However, a write buffer according to embodiments of the invention may include any number of storage elements.

Write buffer 124 is a single-input, single-output write buffer. Write buffer 124 may include a routing block 162, controlled by control signals 150, to provide alternative propagation paths for data chunks from an input port 142 to an output port 146. Routing block 162 has four data-chunk-sized inputs and one data-chunk-sized output. Control signals 150 couple one of the inputs of routing block 162 to the output of routing block 162.

The input of storage element 160A is coupled to input port 142. The inputs of storage elements 160B, 160C, 160D, 160E, 160F and 160G are coupled to the outputs of storage elements 160A, 160B, 160C, 160D, 160E and 160F, respectively. The output of storage element 160H is coupled to output port 46.

Routing block 162 couples storage elements 160D, 160E, 160F and 160G to storage element 160H.

Lengths of alternative propagation paths are independently selectable for each data chunk received through input port 142. Different lengths of propagation paths result in a variable effective depth of the write buffer.

Some propagation paths from input port 142 to output port 146 are presented in TABLE 2 to demonstrate possible lengths of alternative propagation paths. Each row of TABLE 2 represents a propagation path. The length of a propagation path is recorded as the number of storage elements through which a data chunk is propagated, and the storage elements that form part of the propagation path are marked with “X”.

TABLE 2

| | Path | S.E. | S.E. | S.E. | S.E. | S.E. | S.E. | S.E. | S.E. |
|---|---|---|---|---|---|---|---|---|---|
| Path | Length | 160A | 160B | 160C | 160D | 160E | 160F | 160G | 160H |
| aa | 8 | X | X | X | X | X | X | X | X |
| bb | 7 | X | X | X | X | X | X | | X |
| cc | 6 | X | X | X | X | X | | | X |
| dd | 5 | X | X | X | X | | | | X |
| ee | 4 | X | X | X | | | | | X |

It should be noted that the different paths “aa”, “bb”, “cc”, “dd” and “ee” have different lengths. It should also be noted that path “aa” includes all of the storage elements 160, while the other paths exclude at least one of the storage elements. In paths “bb”, “cc”, “dd” and “ee”, the excluded storage elements are a chain of one or more storage elements that immediately precede storage element 160H.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A method comprising:
storing a data chunk in a first storage element of a write buffer, said first storage element directly connected to an input port of said write buffer; and
propagating said data chunk through fewer than all intermediate storage elements of said write buffer to a last storage element of said write buffer, said last storage element directly connected to an output port of said write buffer.

2. The method of claim 1, wherein propagating said data chunk includes bypassing a chain of one or more intermediate storage elements that immediately precedes said last storage element.

3. The method of claim 1, further comprising:
storing another data chunk in said first storage element; and
propagating said other data chunk through all of said intermediate storage elements to said last storage element.

4. A method comprising:
storing a data chunk in an available input storage element of a write buffer; and
propagating said data chunk to an available output storage element of said write buffer by bypassing one or more intermediate storage elements of said write buffer.

5. A method comprising:
propagating data chunks through a write buffer via alternative propagation paths of selected storage elements of said write buffer, wherein lengths of said alternative propagation paths are independently selectable for each of said data chunks according to availability of said storage elements and accessibility of one or more destination devices coupled to one or more output ports of said write buffer.

6. The method of claim 5, wherein said write buffer is a single-input, single-output write buffer.

7. The method of claim 5, wherein said write buffer is a dual-input, dual-output write buffer.

8. An integrated circuit having a processor, the processor comprising:
a store unit; and
a write buffer including at least:
an input port coupled to said store unit;
an output port coupled to one or more destination devices;
a plurality of storage elements; and
one or more configurable routing blocks coupled to said storage elements,
wherein said one or more routing blocks are configured at any given time according to which of said storage elements are available at said given time and which of said one or more destination devices are accessible at said given time.

9. The integrated circuit of claim 8, wherein a last of said storage elements is connected directly to said output port and one of said routing blocks couples said last of said storage elements to a chain of one or more of its preceding storage elements.

10. The integrated circuit of claim 8, wherein said one or more routing blocks are configurable to provide a path from said input port to said output port through selected ones of said storage elements and said path excludes at least one of said storage elements.

11. An integrated circuit having a processor, the processor comprising:
two store units; and
a write buffer including at least:
two input ports each coupled to a respective one of said two store units;
two output ports each coupled to one or more destination devices;
a plurality of storage elements; and
a plurality of configurable routing blocks coupled to said storage elements,
wherein said routing blocks are configured at any given time according to which of said storage elements are available at said given time and which of said destination devices are accessible at said given time.

12. The integrated circuit of claim 11, wherein said write buffer includes eight storage elements, a last of said storage elements is connected directly to one of said output ports and a second last of said storage elements is connected directly to another of said output ports, one of said routing blocks couples said last of said storage elements to its four preceding storage elements and another of said routing blocks couples said second last of said storage elements to its four preceding storage elements.

13. The integrated circuit of claim 12, wherein said routing blocks provide at least two alternative propagation paths for data chunks from one of said input ports to one of said output ports through selected ones of said storage elements.

14. The integrated circuit of claim 13, wherein at least one of said alternative propagation paths excludes at least one of said storage elements.

15. The integrated circuit of claim 13, wherein a last of said storage elements is connected directly to one of said output ports, and said alternative propagation paths include paths that route to said one of said output ports via said last of said storage elements and that exclude a first chain of one or more of its preceding storage elements.

16. The integrated circuit of claim 15, wherein a second last of said storage elements is connected directly to another of said output ports, and said alternative propagation paths include paths that route to said another of said output ports via said second last of said storage elements and that exclude a second chain of one or more of its preceding storage elements.

17. The integrated circuit of claim 16, wherein said write buffer consists of eight storage elements, said first chain consists of at most three storage elements, and said second chain consists of at most three storage elements.

18. An apparatus comprising:
a memory; and
an integrated circuit having a processor, said processor comprising:
a store unit; and
a write buffer including at least:
an input port coupled to said store unit;
an output port coupled to said memory;
a plurality of storage elements; and
one or more configurable routing blocks coupled to said storage elements,
wherein said one or more routing blocks are configured at any given time according to availability of said storage elements at said given time and accessibility of said memory at said given time.

19. The apparatus of claim 18, wherein a last of said storage elements is connected directly to said output port and one of said routing blocks couples said last of said storage elements to a chain of one or more of its preceding storage elements.

20. The integrated circuit of claim 18, wherein said one or more routing blocks are configurable to provide a path from said input port to said output port through selected ones of said storage elements and said path excludes at least one of said storage elements.

21. An apparatus comprising:
one or more memories; and
an integrated circuit having a processor, said processor comprising:
two store units; and
a write buffer including at least:
two input ports each coupled to a respective one of said two store units;
two output ports each coupled to said one or more memories;
a plurality of storage elements; and
a plurality of configurable routing blocks coupled to said storage elements,
wherein said routing blocks are configured at any given time according to which of said storage elements are available at said given time and which of said one or more memories are accessible at said given time.

22. The apparatus of claim 21, wherein said write buffer includes eight storage elements, a last of said storage elements is connected directly to one of said output ports and a second last of said storage elements is connected directly to another of said output ports, one of said routing blocks couples said last of said storage elements to its four preceding storage elements and another of said routing blocks couples said second last of said storage elements to its four preceding storage elements.

23. The apparatus of claim 22, wherein said routing blocks provide at least two alternative propagation paths for data chunks from one of said input ports to one of said output ports through selected ones of said storage elements.

24. The apparatus of claim 23, wherein at least one of said alternative propagation paths excludes at least one of said storage elements.

25. The apparatus of claim 23, wherein a last of said storage elements is connected directly to one of said output ports, and said alternative propagation paths include paths that route to said one of said output ports via said last of said storage elements and that exclude a first chain of one or more of its preceding storage elements.

26. The apparatus of claim 25, wherein a second last of said storage elements is connected directly to another of said output ports, and said alternative propagation paths include paths that route to said another of said output ports via said second last of said storage elements and that exclude a second chain of one or more of its preceding storage elements.

27. The apparatus of claim 26, wherein said write buffer consists of eight storage elements, said first chain consists of at most three storage elements, and said second chain consists of at most three storage elements.
